(19) United States
(12) Patent Application Publication
(10) Pub. No.: US 2019/0384688 A1
(43) Pub. Date: Dec. 19, 2019

(54) Method for Analysing the Rules of Changes Between the Levels of Use of Resources of a Computer System

(71) Applicant: BULL SAS, Les Clayes Sous Bois (FR)

(72) Inventors: Bruno DEMEILLIEZ, Les Clayes Sous Bois (FR); Florent ROCHETTE, Les Clayes Sous Bois (FR); Gilles MENIGOT, Les Clayes Sous Bois (FR)

(21) Appl. No.: 16/477,493

(22) PCT Filed: Jan. 11, 2018
(86) PCT No.: PCT/FR2018/000005

§ 371 Date: Jul. 11, 2019

(30) Foreign Application Priority Data
Jan. 12, 2017 (FR) 1750281

(51) Int. Cl. G06F 11/34; G06F 17/15; G06F 11/30

(52) U.S. Cl. CPC G06F 11/3495; G06F 11/302; G06F 11/3006; G06F 17/15

(57) ABSTRACT

A method for evaluating the performance of an application chain within a computer infrastructure comprising a number N resources denoted Rᵢ (1≤i≤N), where the method comprises the steps of: collecting over a same time interval with a same sampling period a predefined number M of series of measurements Xₖ (1≤k≤M) relating to the level of use of the resources; for all the possible combinations of two series of measurements (Xₖ₁, Xₖ₂), with k1≠k2: creating a plurality of pairs of subsets (X′ₖ₁, X′ₖ₂) by selecting a predefined number nᵥ of values based on the series Xₖ₁ and Xₖ₂; applying an algorithm for searching affine correlation relation(s) over each pair of subsets; calculating the percentages differences between the values of X′ₖ₂(t) and of aX′ₖ₁(t)+b for each index t (between 1 and nᵥ); and calculating the saturation values of the series X′ₖ₂.

The present invention relates to the field of monitoring an IT (Information Technology) infrastructure, this expression denoting all the hardware and software elements forming the computer system of a company or organization. The invention relates more particularly to the field of analyzing resources (notably processors, operating systems and memories) of an IT infrastructure on which there is hosted an application link chain, i.e. for a process, a functional chain connecting several applications which operate together to perform the process.

A number of IT infrastructures are poorly dimensioned, and most often under-dimensioned. Poor dimensioning results in inadequate performance, or even stopping of production. Correctly dimensioning an IT infrastructure is a major challenge for companies for which production depends on the performance of their IT systems. The term “dimensioning” denotes the capacities (computational and memory) of the servers, coupled with the availability of resources (hardware and software).

An increase in the load of an IT system can be accompanied by a gradual saturation of the resources of the system within the same functional chain (or application link chain). The saturation of a resource blocks the increase in the load of the system and therefore prevents the observation of possible saturation of other resources in the chain.

The use of a resource can bring about the use of another resource. By way of example, in the case of an application ordering a calculation to be performed on a machine A and its result to be saved on a machine B, the level of use of the processors of machine A depends on the progress of the save operations on machine B.

Each resource is characterized by a maximum level of use for optimal functioning (for example, twenty-four percent for a processor).

The present invention aims to propose a method for defining a correlation of the level of use of a resource A with respect to the level of use of a resource B in order to determine, when resource B is saturated and resource A is not, the dimensioning of resource B required to reach the maximum level of resource A.

The objective is to dimension, coherently and optimally, the resources of an IT system and prevent the resources from saturating and the consequences thereof.

The search for correlations in the changes of the levels of use of the resources of an application chain aims to predict:
the change in consumptions and the saturations of the resources when the load is increased,
the dimensioning of the resources of an application chain comprising several servers.

Solutions exist for monitoring servers individually, but they do not provide for determining the levels of future use of resources, nor establishing a correlation between the various levels of use of resources of different servers within the same application chain.

An objective of the present invention is to enable an automatic analysis of the consumption of resources of an IT system and derive therefrom correlations between the levels of use of the resources.

To this end, there is proposed a method for evaluating the performance of an application chain within an IT infrastructure, comprising a number N of resources Rᵢ (where i is an integer between 1 and N), comprising the steps of:
collection, over the same time interval and with the same sampling period period_{ech} of a predefined number M of series of measurements Xₖ (where k is an integer between 1 and M) relating to the levels of use of different resources,
for all possible combinations of two series of measurements (Xₖ₁,Xₖ₂), where k1≠k2, among the collected series:
   creation of several pairs of subsets (X′ₖ₁,X′ₖ₂) by selecting a predefined number nᵥ of values from the series of measurements Xₖ₁ and Xₖ₂ respectively,
   application of an affine correlation relationship search algorithm on each pair of subsets (X′ₖ₁,X′ₖ₂), the affine correlation being modeled by the equation X′ₖ₂=aX′ₖ₁+b, where a and b are real numbers,
   calculation, for each pair (X′ₖ₁,X′ₖ₂), of the percentages P(t) of the difference between the values of X′ₖ₂ (t) and of aX′ₖ₁(t)+b according to the formula

$$P ( t ) = 100 \vert \frac{{X}_{k 2}^{′} ( t ) - ( {aX}_{k 1}^{′} ( t ) + b )}{{X}_{k 2}^{′} ( t )} \vert ,$$

at each index t (between 1 and nᵥ),
calculation, for each pair (X′ₖ₁,X′ₖ₂), and provided that all the values of P(t) are less than or equal to a predefined value T, of saturation values

$${X}_{k 1 smin}^{′} = \frac{{X}_{k 2 m i n}^{′} - b}{a} and {X}_{k 1 sm ax}^{′} = \frac{{X}_{k 2 ma x}^{′} - b}{a} ,$$

where X′_{k2 min} and X′_{k2 max} are respectively the minimum and maximum values of the series of measurements X′ₖ₂.

According to various characteristics taken alone or in combination:
the value of nᵥ is between 3 and 60.
each series of measurements is carried out over a time interval greater than or equal to two hours.
each series of measurements is carried out with a sampling period period_{ech} of one minute.
the value T is 95%.
the number of pairs of subsets is between 1 and 100.

The step for selecting the subsets X′ₖ₁ and X′ₖ₂ includes the operations of:
taking into account the following parameters: the minimum values pₘᵢₙ and maximum values pₘₐₓ of a search period denoted by p, where p is a variable of the method, the increment size pₚₐₛ of the period p, a sampling period period_{ech},
creation of the nᵥ values of the subset X′ₖ₁ by selecting nᵥ values in the series Xₖ₁,
creation of the nᵥ values of the subset X′ₖ₂ by selecting nᵥ values in the series Xₖ₂,

The algorithm for searching for an affine relationship between two series of measurements X′ₖ₂ and X′ₖ₁ comprises the operations of:
calculation of a as being the ratio between X′_{k2moy} and X′_{k1moy}, i.e.

$$a = \frac{{X}_{k 2 moy}^{′}}{{X}_{k 1 moy}^{′}} ,$$

where X′_{k2moy} is the average of the differences between the successive values in the list X′ₖ₂, i.e.

$${X}_{k 2 moy}^{′} = \frac{1}{{n}_{v} - 1} {\sum }_{t = 2}^{{n}_{v}} ( {X}_{k 2}^{′} ( t ) - {X}_{k 2}^{′} ( t - 1 ) )$$

and X′_{k1moy} is the average of the differences between successive values in the list X′ₖ₁ i.e.

$${X}_{k 1 moy}^{′} = \frac{1}{{n}_{v} - 1} {\sum }_{t = 2}^{{n}_{v}} ( {X}_{k 1}^{′} ( t ) - {X}_{k 1}^{′} ( t - 1 ) ) ,$$

calculation of b according to the formula

$$b = \frac{a ( {\sum }_{i = 1}^{{n}_{v}} ( {X}_{k 2}^{′} ( t ) - {X}_{k 1}^{′} ( t ) )}{{n}_{v}}$$

where X′ₖ₂(t) and X′ₖ₁(t) are the values in the series X′ₖ₂ and X′ₖ₁ at the index t.

According to various characteristics taken alone or in combination:
the parameter pₘᵢₙ is fixed at a value between 1 and 10.
the parameter pₘₐₓ is fixed at a value between 1 and 100.
the parameter pₚₐₛ is fixed at a value between 1 and 10.

The invention will be better understood and other details, features and advantages of the invention will emerge from reading the following description, given by way of nonlimiting example with reference to the drawings in which:

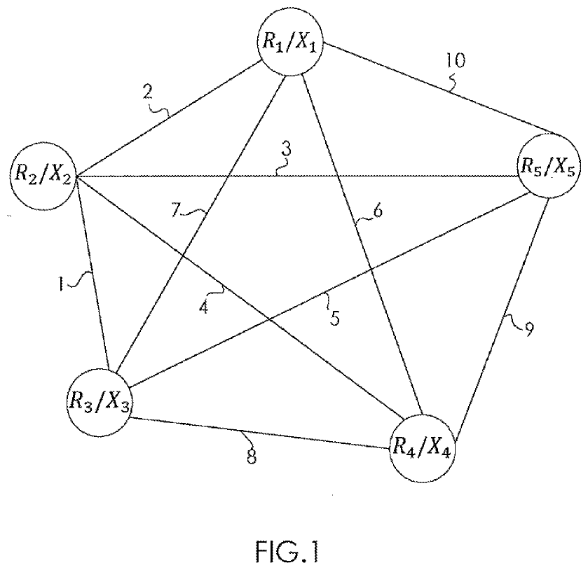

FIG. 1 is a schematic representation of five resources and possible combinations between the series of measurements carried out on these resources.

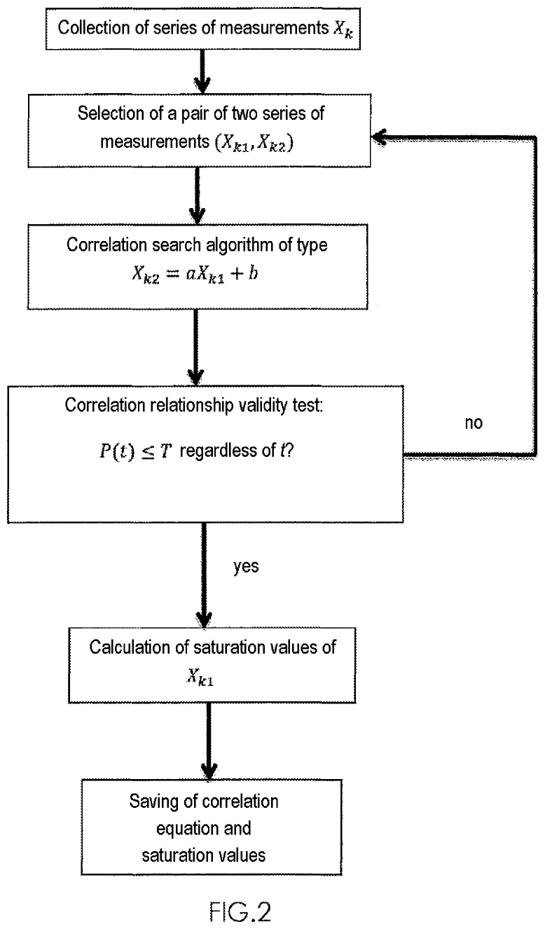

FIG. 2 is a functional diagram illustrating various steps of the method for searching for rules of changes between the various resources of an IT system.

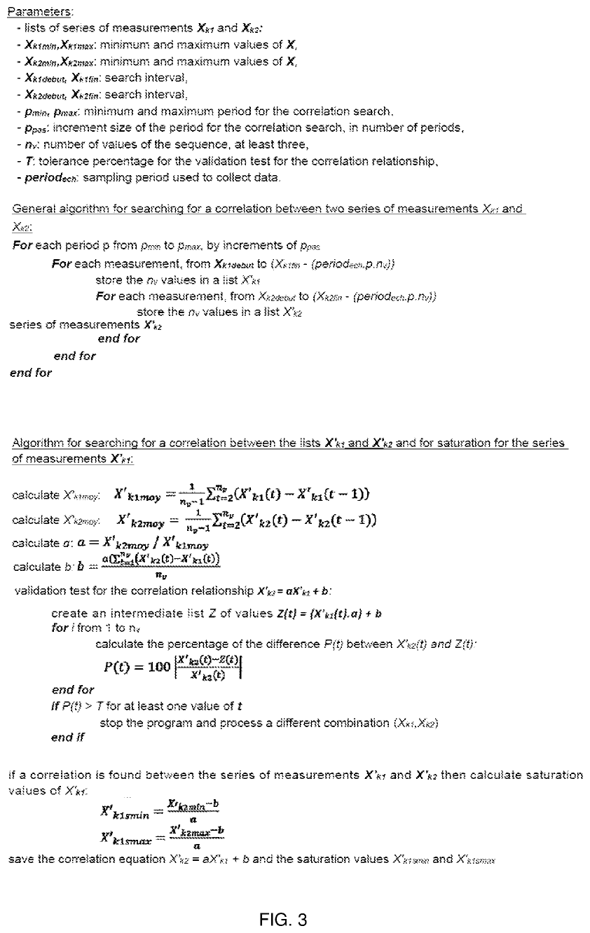

FIG. 3 is a pseudocode describing an example embodiment of the method in the case of searching for a rule of change between two series of measurements.

An IT architecture (or system, or infrastructure) conventionally comprises various hardware and/or software resources which, to perform processes, are connected to each other to form one or more functional chains (or application link chains, or application chains).

To optimize the operation of such an application chain, its performance and notably the use of the resources forming it must be evaluated. N (where N is an integer) denotes the number of resources, denoted by Rᵢ (where i is an integer such that 1≤i≤N), of the application chain.

To evaluate the performance of the application chain, the principle is to search for the rules of change between several series of measurements performed on the resources, typically the level of use, load, available memory, occupied disk space or memory. “Rule of change” is understood to mean an affine type correlation relationship between two series of measurements relating to levels of use of resources Rᵢ. FIG. 1 provides an example of five resources Rᵢ (1≤i≤N, N=5), denoted by R₁ to R₅.

One step in the method involves performing and collecting a plurality of series of measurements denoted by Xₖ, each measurement supplying a level (or rate) of use of a resource Rᵢ. These series are denoted by X₁ to X₅ in the example of FIG. 1. The level of use of a resource is a physical quantity, the nature of which can vary according to the type of resource examined. It can be the power consumed in the case of a processor (for example, a central processing unit), a percentage of the maximum transfer rate in the case of a hard disk, or a percentage of the total capacity (or occupation rate) in the case of random access memory.

FIG. 2 illustrates the main steps of the method.

A preliminary step consists in collecting a predefined number M (where M is an integer not necessarily equal to N) of series of measurements Xₖ(1≤k≤M) carried out over the same time interval and with the same sampling period denoted by period_{ech}.

The measurements are advantageously carried out automatically by a program executed on one or more servers incorporated in the IT infrastructure.

The measurements are preferably performed (and collected) over a time interval of at least two hours, with a sampling period of one minute. By way of example, the measurements are carried out over a period of four hours (typically between 08:00 and 12:00), with a sampling period of one minute (i.e. two successive measurements are spaced out by one minute).

The measurements provide, for example, for determining the level of activity of a central processing unit (CPU) and disks of two servers. In this example, the method proposed by the present invention provides for determining affine type correlations between the activities of processors and disks of two servers, in all possible combinations:
correlation between the level of activity of the CPU of the first server and that of its own disk,
correlation between the level of activity of the CPU of the first server and that of the disk of the second server,
correlation between the level of activity of the CPU of the second server and that of its own disk,
correlation between the level of activity of the CPU of the second server and that of the disk of the first server,
correlation between the level of activity of the CPU of the first server and that of the CPU of the second server,
correlation between the level of activity of the disk of the first server and that of the disk of the second server,

A series of measurements can be the result of one measurement or the combining of the results of several measurements carried out simultaneously. For example, a series of measurements can contain the sum of the data rates of all the disks present on the machine.

The correlation search method proposed by the present invention aims, for a set of series of measurements collected, to establish correlation relationships between different pairs of series of measurements denoted by (Xₖ₁,Xₖ₂) (where k1 and k2 are integers between 1 and M and where k1≠k2) from the collected measurements. Each pair of series of measurements corresponds to a particular combination of two series of measurements. In the example of FIG. 1, if a series of measurements Xₖ is collected for each resource Rᵢ, i.e. each series of measurements Xₖ corresponds to the level of use of a resource Rᵢ, then there will be 10 possible pairs of series of measurements denoted by 1 to 10. Recall that an objective of the present invention is the determination of correlation relationships for all possible combinations of two series of measurements.

A first step consists in selecting two series of measurements Xₖ₁ and Xₖ₂ from the set of series of measurements collected.

A second step consists in searching for an affine correlation relationship over at least nᵥ values (where nᵥ is an adjustable integer) between the two series of measurements Xₖ₁ and Xₖ₂. This affine correlation relationship is illustrated by equation (1):

Xₖ₂=aXₖ₁+b (1)
where a and b are real numbers.

Percentages P(t) of the difference between the values Xₖ₂(t) and aXₖ₁(t)+b are calculated, Xₖ₂(t) referring to the value of the measurement of index t in the series Xₖ₂, and Xₖ₁(t) referring to the value of the measurement of index t in the series Xₖ₁. This calculation is illustrated by equation (2), these percentages being defined as follows:

$$P ( t ) = 100 \vert \frac{{X}_{k 2} ( t ) - ( {aX}_{k 1} ( t ) + b )}{{X}_{k 2} ( t )} \vert \qquad ( 2 )$$

where t is an integer index such that 1≤t≤nᵥ.

If each value of P(t) obtained is less than or equal to a predefined value T, for example fixed by an operator (typically the network administrator), then the affine correlation relationship (1) is validated and saved. T is called the tolerance percentage and is advantageously fixed at 95%. According to a preferred embodiment, nᵥ is advantageously between 3 and 60.

In this case, the method comprises a next step for calculating saturation values X_{k1s min} and X_{k1s max} for the series of measurements Xₖ₁ using the following formulas (3) and (4):

$$\begin{matrix}{X}_{k 1 smin} = \frac{{X}_{k 2 m i n} - b}{a} & ( 3 ) \\ {X}_{k 1 smax} = \frac{{X}_{k 2 ma x} - b}{a} & ( 4 )\end{matrix}$$

where X_{k2 min} and X_{k2 max} are the minimum and maximum values, respectively, of the series of measurements Xₖ₂. If at least one of the values X_{k1s min} or X_{k1s max} belongs to the interval ]X_{k1 min},X_{k1 max}[ where X_{k1 min} and X_{k1 max} are the minimum and maximum values of the series Xₖ₁, then the rule of change found is such that the resource associated with the series of measurements Xₖ₂ will saturate before the resource associated with the series of measurements Xₖ₁. More specifically, the resource Xₖ₂ will begin to saturate when the resource Xₖ₁ comes close to the value of X_{k1s min}.

If no correlation relationship has been found, an additional step consists in processing the next combination of series of measurements, this step being repeated until all the possible combinations have been analyzed. One variant consists in carrying out this same process for a multitude of pairs of subsets (X′ₖ₁,X′ₖ₂) obtained from a pair of series of measurements (Xₖ₁,Xₖ₂). In this case, the series X′ₖ₁ is obtained by selecting a predefined number nᵥ of values in the series Xₖ₁. Likewise, X′ₖ₂ is obtained from Xₖ₂.

FIG. 1 illustrates an example in which the correlation relationship is calculated directly on the series of measurements Xₖ₁ and Xₖ₂, thereby corresponding to the particular case in which nᵥ is equal to the number of values contained in each series Xₖ₁ or Xₖ₂. A variant of the method consists in calculating correlation relationships on subsets (X′ₖ₁,X′ₖ₂) obtained from a pair of series of measurements (Xₖ₁,Xₖ₂) as indicated earlier. This possibility is offered to the user by proposing an initial configuration illustrated in FIG. 3. This example is provided for an example pair of series of measurements denoted by (Xₖ₁,Xₖ₂). The same steps are applied on all the possible combinations of series of measurements (Xₖ₁,Xₖ₂) from the collected data.

The parameters that can be adjusted by the user are:
[X_{k1deb},X_{k1fin}]: an interval for searching values,
[Y_{k2deb},Y_{k2fin}]: an interval for searching values,
pₘᵢₙ: the minimum value of variable p corresponding to a period for selecting subsets X′ₖ₁ and X′ₖ₂,
pₘₐₓ: the maximum value of the period p,
pₚₐₛ: the increment size for the period p,
nᵥ: the number of values in each subset X′ₖ₁ and X′ₖ₂,
T: the tolerance percentage for the validation of a correlation relationship between the series X′ₖ₁ and X′ₖ₂.

For the particular case in which the values of pₘᵢₙ, pₘₐₓ and pₚₐₛ are 1, the search intervals cover all the values of Xₖ₁ and Xₖ₂, and nᵥ is equal to the size of the sequence Xₖ₁ and to the size of Xₖ₂. The value of p will then be 1 and the subsets X′ₖ₁ and X′ₖ₂ will be the same as the initial series Xₖ₁ and Xₖ₂. The search is then performed directly on the series of measurements Xₖ₁ and Xₖ₂.

To construct a subset X′ₖ₁ from Xₖ₁, the operation consists in selecting a value on nₛ in Xₖ₁ and in incorporating it into the subset X′ₖ₁. For example, if nₛ is 2, a value on 2 will be selected in Xₖ₁ to construct X′ₖ₁.

If for example pₘᵢₙ is 1, pₘₐₓ is 8 and pₚₐₛ is 2, then the values of the variable nₛ will successively be 2, 4, 6 and 8. This results in four pairs of subsets (X′ₖ₁,X′ₖ₂) for which a correlation relationship will be sought. A correlation relationship is found for the series Xₖ₁ and Xₖ₂ if correlation relationships are found for all the pairs of subsets (X′ₖ₁,X′ₖ₂) generated. If during the process, a correlation relationship is not found for at least one pair of subsets, then no correlation is generated between the series of measurements. In that case, a new combination of series of measurements (X′ₖ₁,X′ₖ₂) is selected in the collected data and the process is restarted.

The benefit of working on pairs of subsets (X′ₖ₁,X′ₖ₂) of pairs of series of initial measurements (Xₖ₁,Xₖ₂), and not directly on the series of initial measurements is to provide an indicator of the relevance of the correlation found. Specifically, for a pair of series of measurements (Xₖ₁,Xₖ₂), and provided that correlations are found for all the subsets (X′ₖ₁,X′ₖ₂) generated, the greater the number of subsets, the stronger the correlation relationship between the series of measurements Xₖ₁ and Xₖ₂. According to a preferred embodiment, the number of pairs of subsets used is between 1 and 100.

The variation in the sampling period p, between pₘᵢₙ and pₘₐₓ, provides for taking into account only the extreme values (high or low, for example in the case of a series of measurements representing a sinusoidal curve).

At the end of this step, a pair of two subsets X′ₖ₁ and X′ₖ₂ is obtained, each containing nᵥ values.

An affine type correlation equation is sought between these two subsets. It can be expressed as in equation (1): X′ₖ₂=aX′ₖ₁+b.

The value of a is calculated by calculating the ratio between the average X′_{k2moy} of the differences between the successive values in the list X′ₖ₂ and the average X′_{k1moy} of the differences between the successive values in the list X′ₖ₁. The calculation of a is illustrated by equation (5):

$$a = \frac{{X}_{k 2 moy}^{′}}{{X}_{k 1 moy}^{′}} , \qquad ( 5 )$$

The calculations of the average values X′_{k2moy} and X′_{k1moy} are illustrated by equations (6) and (7):

$$\begin{matrix}{X}_{k 2 moy}^{′} = \frac{1}{{n}_{v} - 1} {\sum }_{t = 2}^{{n}_{v}} ( {X}_{k 2}^{′} ( t ) - {X}_{k 2}^{′} ( t - 1 ) ) & ( 6 ) \\ {X}_{k 1 moy}^{′} = \frac{1}{{n}_{v} - 1} {\sum }_{t = 2}^{{n}_{v}} ( {X}_{k 1}^{′} ( t ) - {X}_{k 1}^{′} ( t - 1 ) ) & ( 7 )\end{matrix}$$

The calculation of the value of b is illustrated by equation (8):

$$b = \frac{a ( {\sum }_{t = 1}^{{n}_{v}} ( {X}_{k 2}^{′} ( t ) - {X}_{k 1}^{′} ( t )}{{n}_{v}} \qquad ( 8 )$$

where X′ₖ₂(t) and X′ₖ₁(t) are the respective values in the series X′ₖ₂ and X′ₖ₁ at index t.

The next step is the test for the reliability of the correlation relationship thus generated. To that end, an example embodiment consists in generating a list Z from nᵥ values of the list X′ₖ₁ in which each value Z(t) is connected to the value X′ₖ₁(t) by the affine correlation relationship (1): Z(t)=aX′ₖ₁(t)+b. Each percentage P(t) of the difference between the values Z(t) and X′ₖ₂(t) is calculated, as illustrated in equation (9):

$$P ( t ) = 100 \vert \frac{{X}_{k 2}^{′} ( t ) - Z ( t )}{{X}_{k 2}^{′} ( t )} \vert \qquad ( 9 )$$

The step consisting in generating a list Z(t) is an intermediate step which is not indispensable for calculating the percentage P(t), which can be calculated directly as shown by equation (2). This step generates a sequence of percentages that can be denoted by P and which contain nᵥ values denoted by P(t).

If at least one value of P(t) is strictly greater than the tolerance percentage T, then there is no correlation between the series of measurements X′ₖ₁ and X′ₖ₂, and the search algorithm processes the next combination of series of measurements. If among a multitude of pairs of subsets (X′ₖ₁,X′ₖ₂), one among them does not provide a correlation equation, then it is considered that there is no correlation between the series of measurements Xₖ₁ and Xₖ₂ (from which the subsets were generated).

If all the values of P(t) are less than or equal to the tolerance percentage T, then the correlation equation X′ₖ₂=aX′ₖ₁+b is validated for the pair of subsets X′ₖ₁ and X′ₖ₂. In that case, the next step is calculating the saturation values X′_{k1s min} and X′_{k1s max} in the same way as in equations (3) and (4), replacing X_{k2 min} and X_{k2 max} by X′_{k2 min} and X′_{k2 max}, and as illustrated in FIG. 3.

If a correlation relationship is found for each pair of subsets (X′ₖ₁,X′ₖ₂), then a correlation exists between the initial series of measurements Xₖ₁ and Xₖ₂. The final values of a, b and the saturation values X_{k1s min} and X_{k1s max} are obtained by calculating the average of the values obtained for the subsets exhibiting a correlation.

Thus, this method provides for generating correlation relationships between several series of measurements, which may be used to define a better dimensioning of production infrastructures.

1. A method for evaluating the performance of an application chain within an IT (Information Technology) infrastructure, comprising a number N of resources Rᵢ (where i is an integer between 1 and N), comprising the steps of:
collection, over the same time interval and with the same sampling period period_{ech} of a predefined number M of series of measurements Xₖ, where k is an integer between 1 and M, relating to the levels of use of different resources,
for all possible combinations of two series of measurements (Xₖ₁,Xₖ₂), where k1≠k2, among the collected series:
creation of several pairs of subsets (X′ₖ₁,X′ₖ₂) by selecting a predefined number nᵥ of values from the series of measurements Xₖ₁ and Xₖ₂ respectively,
application of an affine correlation relationship search algorithm on each pair of subsets (X′ₖ₁,X′ₖ₂), this affine correlation being modeled by the equation X′ₖ₂=aX′ₖ₁+b, where a and b are real numbers,
calculation, for each pair (X′ₖ₁,X′ₖ₂), of the percentages P(t) of the difference between the values of X′ₖ₂(t) and of aX′ₖ₁(t)+b according to the formula
$$P ( t ) = 100 \vert \frac{{X}_{k 2}^{′} ( t ) - ( {aX}_{k 1}^{′} ( t ) + b )}{{X}_{k 2}^{′} ( t )} \vert ,$$
at each index t (between 1 and nᵥ),
calculation, for each pair (X′ₖ₁,X′ₖ₂), and provided that all the values of P(t) are less than or equal to a predefined value T, of saturation values
$${X}_{k 1 smin}^{′} = \frac{{X}_{k 2 m i n}^{′} - b}{a} and {X}_{k 1 smax}^{′} = \frac{{X}_{k 2 m ax}^{′} - b}{a} ,$$
where X′_{k2 min} and X′_{k2 max} are respectively the minimum and maximum values of the series of measurements X′ₖ₂.

2. The method as claimed in claim 1, characterized in that the value of nᵥ is between 3 and 60.

3. The method as claimed in claim 1, characterized in that each series of measurements is carried out over a time interval greater than or equal to two hours.

4. The method as claimed in claim 1, characterized in that each series of measurements is carried out with a sampling period period_{ech} of one minute.

5. The method as claimed in claim 1, characterized in that the value T is 95%.

6. The method as claimed in claim 1, characterized in that the number of pairs of subsets is between 1 and 100.

7. The method as claimed in claim 1, characterized in that the selection of the subsets X′ₖ₁ and X′ₖ₂ includes the operations of:
taking into account the following parameters: the minimum values pₘᵢₙ and maximum values pₘₐₓ of a search period denoted by p, where p is a variable of the method, the increment size pₚₐₛ of the period p, a sampling period period_{ech},
creation of the nᵥ values of the subset X′ₖ₁ by selecting nᵥ values in the series Xₖ₁,
creation of the nᵥ values of the subset X′ₖ₂ by selecting nᵥ values in the series Xₖ₂.

8. The method as claimed in claim 7, characterized in that the parameter pₘᵢₙ is fixed at a value between 1 and 10.

9. The method as claimed in claim 7, characterized in that the parameter pₘₐₓ is fixed at a value between 1 and 100.

10. The method as claimed in claim 7, characterized in that the parameter pₚₐₛ is fixed at a value between 1 and 10.

11. The method as claimed in claim 1, characterized in that the algorithm for searching for an affine relationship between two series of measurements X′ₖ₂ and X′ₖ₁ comprises the operations of:
calculation of a as being the ratio between X′_{k2moy} and X′_{k1moy}, i.e.
$$a = \frac{{X}_{k 2 moy}^{′}}{{X}_{k 1 moy}^{′}} ,$$
where X′_{k2moy} is the average of the differences between the successive values in the list X′ₖ₂, i.e.
$${X}_{k 2 moy}^{′} = \frac{1}{{n}_{v} - 1} {\sum }_{t = 2}^{{n}_{v}} ( {X}_{k 2}^{′} ( t ) - {X}_{k 2}^{′} ( t - 1 ) )$$
and X′_{k1moy} is the average of the differences between the successive values in the list X′ₖ₁ i.e.
$${X}_{k 1 moy}^{′} = \frac{1}{{n}_{v} - 1} {\sum }_{t = 2}^{{n}_{v}} ( {X}_{k 1}^{′} ( t ) - {X}_{k 1}^{′} ( t - 1 ) ) ,$$
calculation of b according to the formula
$$b = \frac{a ( {\sum }_{i = 1}^{{n}_{v}} ( {X}_{kz}^{′} ( t ) - {X}_{k 1}^{′} ( t ) )}{{n}_{v}}$$
where X′ₖ₂(t) and X′ₖ₁(t) are the values in the series X′ₖ₂ and X′ₖ₁ at the index t.
